(19) United States
(12) Patent Application Publication
(10) Pub. No.: US 2025/0351195 A1
(43) Pub. Date: Nov. 13, 2025

(54) CBRA ENHANCEMENT WITHOUT SSB GROUPING

(71) Applicant: QUALCOMM INCORPORATED, San Diego, CA (US)

(72) Inventors: Shaozhen GUO, Beijing (CN); Mostafa KHOSHNEVISAN, San Diego, CA (US); Peter GAAL, San Diego, CA (US); Xiaoxia ZHANG, San Diego, CA (US)

(21) Appl. No.: 19/124,824

(22) PCT Filed: Nov. 14, 2022
(86) PCT No.: PCT/CN2022/131712

§ 371 Date: Apr. 25, 2025

(51) Int. Cl. H04W 74/0838; H04W 72/23; H04W 76/38

(52) U.S. Cl. CPC H04W 74/0838; H04W 72/23; H04W 76/38

(57) ABSTRACT

A UE may receive, via a transceiver, a configuration of two TAGs for an SpCell from a network entity. The two TAGs may include a first TAG and a second TAG. The UE may receive, via the transceiver, a first TA value from a first network node based on a CBRA process. The UE may perform a single-TAG operation based on the first TAG and the first TA value. The UE may receive, via the transceiver, a second TA value associated with the second TAG from a second network node based on a CFRA process associated with the second TAG. The UE may perform a two-TAG operation based on the first TAG, the first TA value, the second TAG, and the second TA value.

### TECHNICAL FIELD

The present disclosure relates generally to communication systems, and more particularly, to timing advance (TA) configurations in a multi-transmit receive point (multi-TRP) configuration in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive a configuration of two timing advance groups (TAGs) for a special cell (SpCell) from a network entity. The two TAGs may include a first TAG and a second TAG. The apparatus may receive a first timing advance (TA) value from a first network node based on a contention-based random access (CBRA) process. The apparatus may perform a single-TAG operation based on the first TAG and the first TA value. The apparatus may receive a second TA value associated with the second TAG from a second network node based on a contention-free random access (CFRA) process associated with the second TAG. The apparatus may perform a two-TAG operation based on the first TAG, the first TA value, the second TAG, and the second TA value.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example multi-downlink control information (DCI) based multi-TRP transmissions.

FIG. 5 is a diagram illustrating TA configurations associated with a multi-DCI based multi-TRP operation.

FIG. 6 is a diagram illustrating an example TA operation.

FIG. 7 is a diagram illustrating an example method of wireless communication according to one or more aspects.

FIG. 8 is a diagram illustrating an example method of wireless communication according to one or more aspects.

FIG. 9 is a diagram illustrating an example method of wireless communication according to one or more aspects.

FIG. 10 is a diagram of a communication flow of a method of wireless communication.

FIG. 11 is a flowchart of a method of wireless communication.

FIGS. 12A, 12B are flowcharts of a method of wireless communication.

FIG. 13 is a diagram illustrating an example of a hardware implementation for an example apparatus and/or network entity.

### DETAILED DESCRIPTION

If a UE is not aware of the association between synchronization signal blocks (SSBs) and TRPs (i.e., which SSBs are associated with the first TRP and which SSBs are associated with the second TRP) in a multi-DCI based multi-TRP operation, the UE may select an SSB associated with either a first TRP or a second TRP. Thus, the physical random access channel (PRACH) transmission (i.e., a PRACH preamble) may be towards the first TRP or the second TRP. During the CBRA process, the UE may receive a TA command (e.g., an absolute TA command) including a TA value (e.g., an absolute TA value) in a random access response (RAR) message (e.g., via a physical downlink shared channel (PDSCH)) (or in a message B (msgB)). To apply the TA value acquired through the CBRA process to the correct TRP, the UE may need to identify the TRP to which the (absolute) TA command applies.

According to one or more aspects, a UE may receive, via a transceiver, a configuration of two TAGs for an SpCell from a network entity. The two TAGs may include a first TAG and a second TAG. The UE may receive, via the transceiver, a first TA value from a first network node based on a CBRA process. The UE may perform a single-TAG operation based on the first TAG and the first TA value. The UE may receive, via the transceiver, a second TA value associated with the second TAG from a second network node based on a CFRA process associated with the second TAG. The UE may perform a two-TAG operation based on the first TAG, the first TA value, the second TAG, and the second TA value. Accordingly, an (absolute) TA command may be applied to a correct TAG and/or a correct control resource set (CORESET) pool (which may be associated with a corresponding CORESETPoolIndex value) in a multi-DCI based multi-TRP operation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

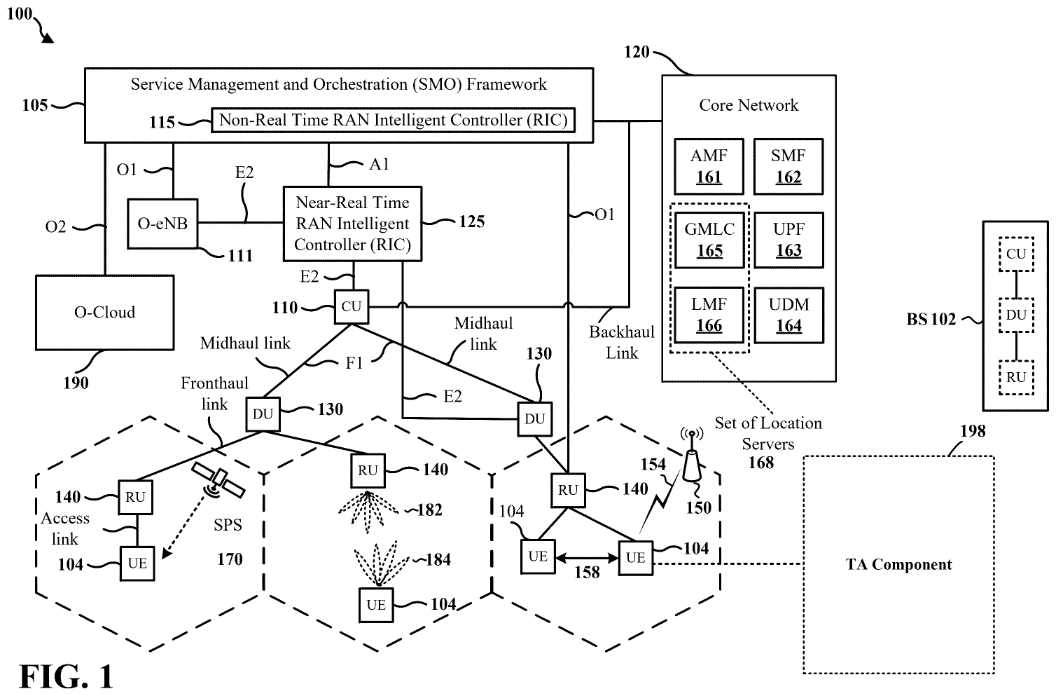

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU)(including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a TA component 198 that may be configured to receive a configuration of two TAGs for an SpCell from a network entity. The two TAGs may include a first TAG and a second TAG. The TA component 198 may be configured to receive a first TA value from a first network node based on a CBRA process. The TA component 198 may be configured to perform a single-TAG operation based on the first TAG and the first TA value. The TA component 198 may be configured to receive a second TA value associated with the second TAG from a second network node based on a CFRA process associated with the second TAG. The TA component 198 may be configured to perform a two-TAG operation based on the first TAG, the first TA value, the second TAG, and the second TA value. Although the following description may be focused on 5G NR, the concepts described herein may be applicable to other similar areas, such as LTE, LTE-A, CDMA, GSM, and other wireless technologies.

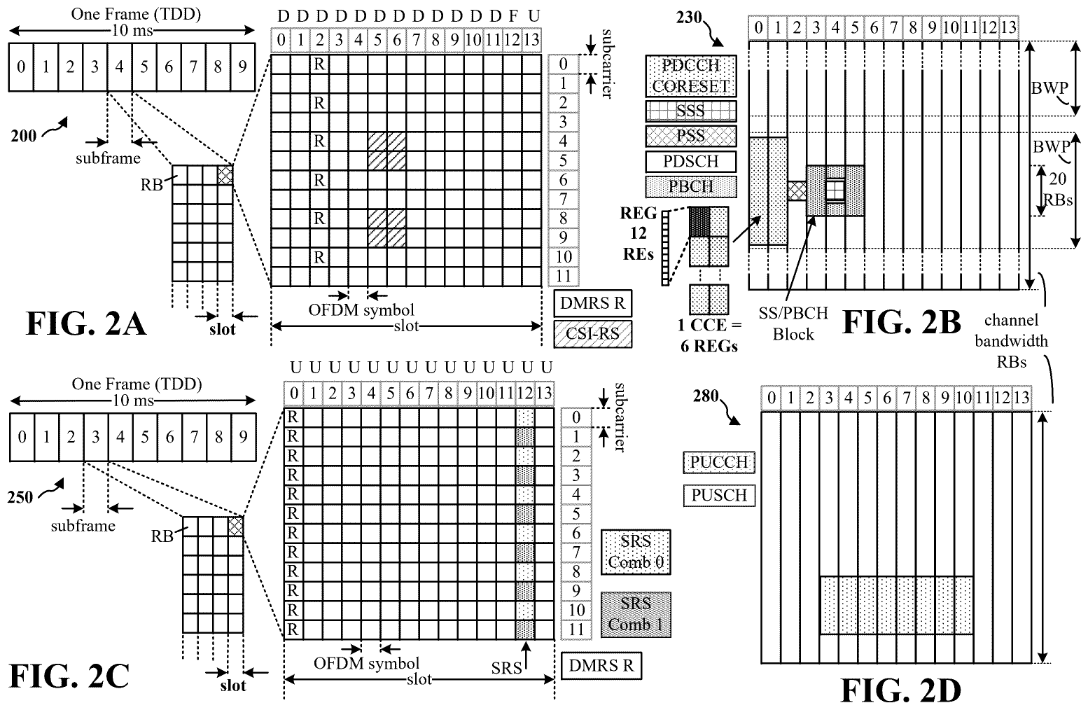

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS)(indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

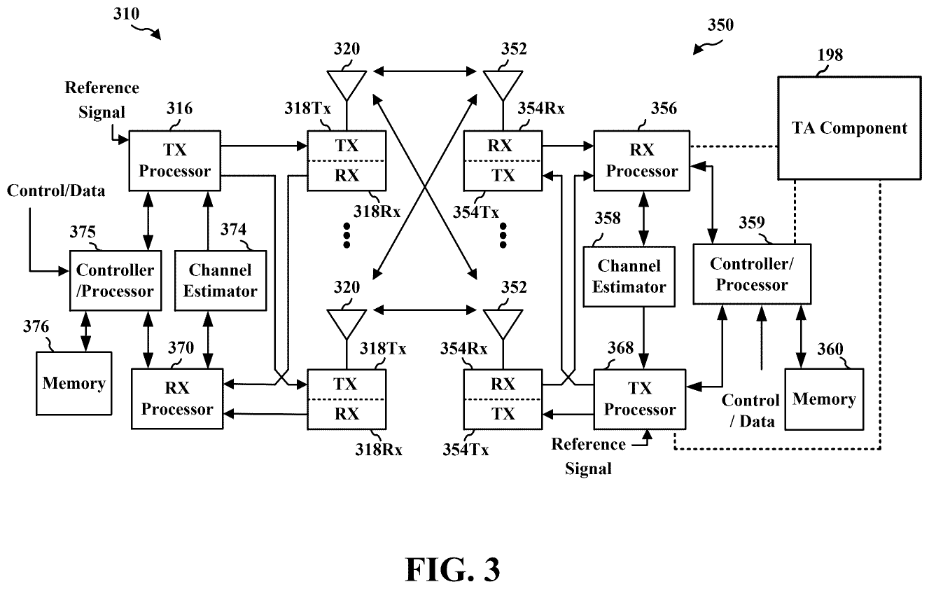

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the TA component 198 of FIG. 1.

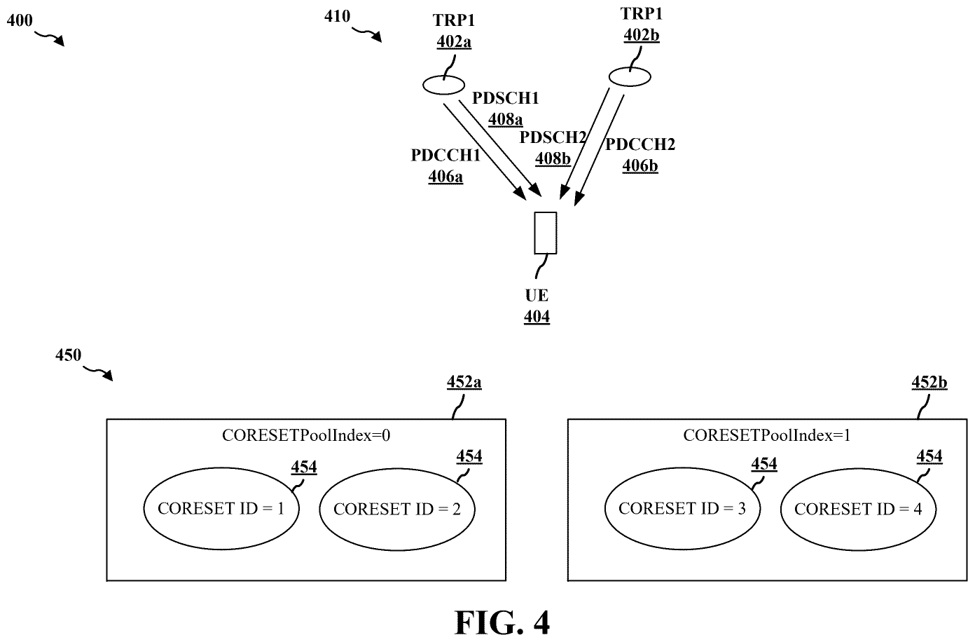

FIG. 4 is a diagram 400 illustrating example multi-DCI based multi-TRP transmissions. As shown in the diagram 410, a first DCI message, which may be transmitted by a first TRP 402a and carried via a first PDCCH 406a, may schedule a first PDSCH 408a (or a first PUSCH, not shown) for a UE 404, where the first PDSCH 408a may be transmitted from the first TRP 402a to the UE 404. It should be appreciated that a PDSCH may be transmitted from a TRP to the UE 404 and a PUSCH may be transmitted from the UE 404 to a TRP. Further, a second DCI message, which may be transmitted by a second TRP 402b and carried via a second PDCCH 406b, may schedule a second PDSCH 408b (or a second PUSCH, not shown) for the UE 404, where the second PDSCH 408b may be transmitted from the second TRP 402b to the UE 404.

In different configurations, a UE (e.g., the UE 404) may differentiate between different TRPs based on CORESET pool indexes (e.g., “CORESETPoolIndex” values) associated with the TRPs. Each CORESET (e.g., up to 5 CORESETs may be configured) may be associated with a CORESET pool, and may be configured with a corresponding CORESETPoolIndex value. In one configuration, the CORESETPoolIndex value may be 0 or 1. In other words, the CORESETs may be grouped into two separate groups based on the CORESETPoolIndex values. As shown in the example diagram 450, a first CORESET group (CORESET pool) 452a corresponding to a CORESETPoolIndex value of 0 (i.e., the index of the group may be 0) may include the CORESETs 454 with the identifiers (IDs) of 1 and 2, and a second CORESET group (CORESET pool) 452b corresponding to a CORESETPoolIndex value of 1 (i.e., the index of the group may be 1) may include the CORESETs 454 with the IDs of 3 and 4. Other than being associated with one of the CORESETPoolIndex values, the different physical TRPs may be transparent to the UE. In other words, the UE may differentiate between different CORESETPoolIndex values, which, according to the actual network implementation, may correspond to different physical TRPs. The UE may not directly differentiate between different physical TRPs.

In some configurations, a UE may be configured with multi-DCI based multi-TRP transmissions if the UE is configured with a higher layer (e.g., RRC) parameter PDCCH-Config that includes two different CORESETPoolIndex values in the CORESETs configured for the active BWP of a serving cell of the UE.

In different configurations, different TRPs may be associated with a same PCI (i.e., intra-cell) or different PCIs (i.e., inter-cell). For example, different TRPs may be associated with a same PCI when the TRPs correspond to different (antenna) panels or remote radio heads (RRHs) of the same cell (base station). It should be appreciated that even if the different TRPs are associated with different PCIs, from the UE's point of view, the multi-TRP configuration may still be defined in a given serving cell and the UE may be aware of just one PCI (e.g., the PCI acquired by the UE during the cell search).

In some configurations, for an inter-cell multi-TRP configuration, the maximum number of additional RRC-configured PCIs per component carrier (CC) (which may be denoted by X) may be reported by the UE to the network in UE capability reporting. In some configurations, two independent values for X (e.g., X1, X2) may be reported by the UE in the UE capability reporting for two different assumptions about additional SSB time domain positions and/or periodicities with respect to the serving cell SSB. In particular, in a first case, X1 may be the maximum number of configured additional PCIs when SSB time domain positions and/or periodicities associated with the additional PCIs are the same as SSB time domain positions and/or periodicities associated with the serving cell PCI. In a second case, X2 may be the maximum number of configured additional PCIs when SSB time domain positions and/or periodicities associated with the additional PCIs are not the same as SSB time domain positions and/or periodicities associated with the serving cell PCI. Accordingly, the first case and the second case may not be enabled simultaneously. In some example configurations, from the perspective of RRC signaling, the number of configured additional PCIs may be selected from the set {1, 2, 3, 4, 5, 6, 7}. In some configurations, the UE may report different capabilities (e.g., including different values for X) for FR1 and FR2.

In some configurations, the center frequency, the SCS, and/or the SFN offset may be assumed to be the same for SSBs from the serving cell and for the SSBs configured with PCIs different from that of the serving cell for the inter-cell multi-TRP operation.

In some configurations, an indicator (e.g., a re-index of the non-serving cell) used with RRC signaling may indicate the non-serving cell information with which a transmission configuration indicator (TCI) state/quasi co-location (QCL) information is associated. In some configurations, the indicator may be different from the PCI of the non-serving cell.

In some configurations, the serving cell PCI may be associated with active TCI states (i.e., TCI states activated based on a MAC-control element (MAC-CE)). Further, in some configurations, just 1 additional PCI may be associated with the active TCI states. For the inter-cell multi-TRP operation, a first PCI associated with one or more active/activated TCI states (e.g., for the PDSCH/PDCCH) may be associated with a first CORESET pool (which may be associated with a CORESETPoolIndex value), and a second PCI associated with one or more active/activated TCI states (e.g., for the PDSCH/PDCCH) may be associated with a second CORESET pool (which may be associated with a second CORESETPoolIndex value). In some configurations, at least one of the first PCI and the second PCI may be a serving cell PCI, and at most one of the first PCI and the second PCI may be a non-serving cell PCI.

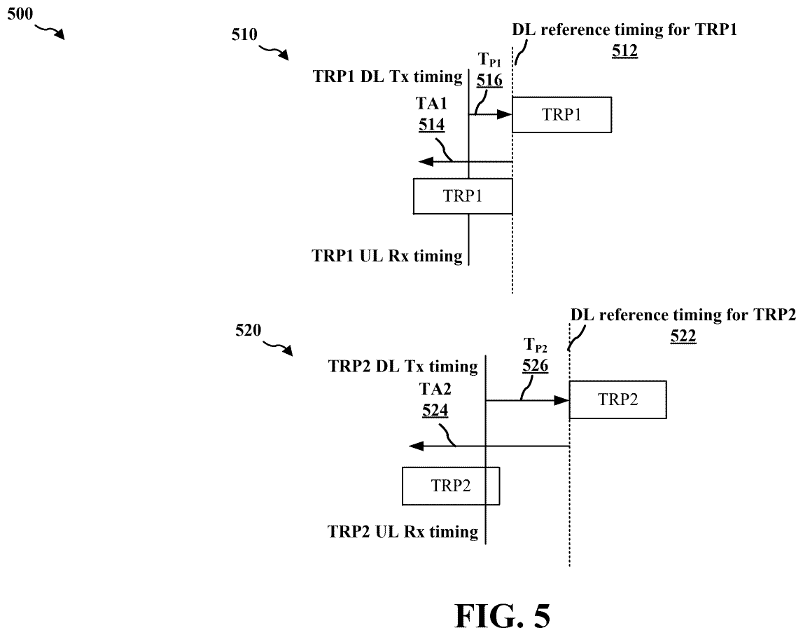

FIG. 5 is a diagram 500 illustrating timing advance (TA) configurations associated with a multi-DCI based multi-TRP operation. For the multi-DCI based multi-TRP operation with two TA values (e.g., one TA value for each of the TRPs) in a CC, two DL reference timings may be supported, where each DL reference timing may be associated with one TA group (TAG). In one configuration, the RX timing difference between the two DL reference timings may not be greater than the CP length. In another configuration, based on the UE capability, the RX timing difference between the two DL reference timings may be greater than the CP length. The diagram 510 may show the TA configuration for a first TRP. The TA configuration for the first TRP may include a DL reference timing for the first TRP 512, a first TA value 514, and a first Tr (propagation delay) value 516. As shown, based on the TA configuration, the DL TX timing and the UL RX timing at the first TRP may align. Further, similarly, the diagram 520 may show the TA configuration for a second TRP. The TA configuration for the second TRP may include a DL reference timing for the second TRP 522, a second TA value 524, and a second TN (propagation delay) value 526. As shown, based on the TA configuration, the DL TX timing and the UL RX timing at the second TRP may align.

In some configurations, for the multi-DCI based multi-TRP operation with two TA values, up to two “n-TimingAdvanceOffset” values per serving cell may be supported. The “n-TimingAdvanceOffset” value may be explained in further detail below.

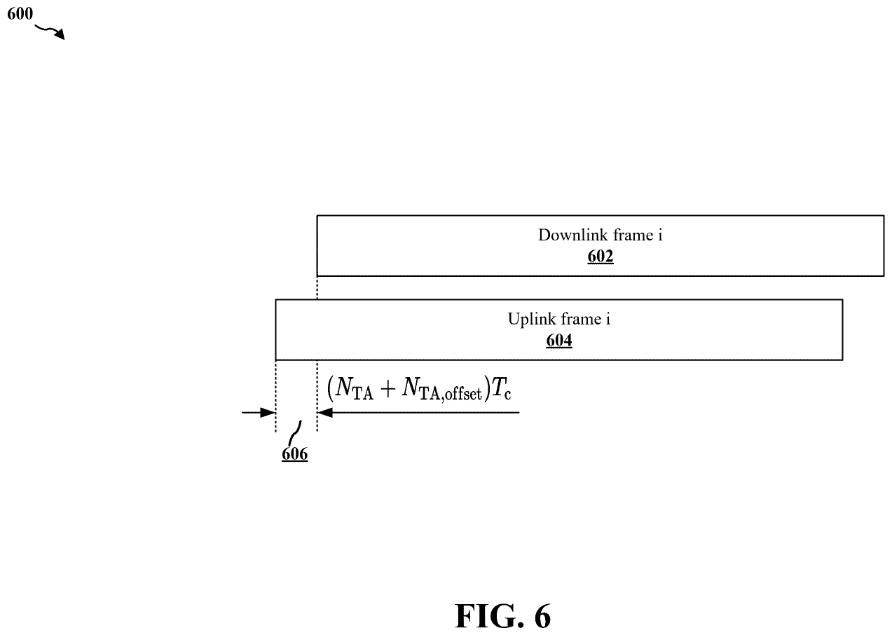

FIG. 6 is a diagram 600 illustrating an example TA operation. As shown, the UE may start the transmission of the uplink frame (with the frame number 1) 604 a TA period 606 (which may correspond to a TA value) before the start of the corresponding downlink frame (with the frame number i) 602 at the UE. In particular, the TA period 606 may be calculated based on the formula T_{TA}=(N_{TA}+N_{TA,offset}) T_{c}. In some aspects, T_{TA} may be referred to as the TA value. Based on the formula, when a TA command includes an N_{TA} value, the TA command may implicitly include/indicate a T_{TA} value (TA value). Further, in general, N_{TA,offset} (also referred to as the “n-TimingAdvanceOffset” value) may be given in the 3GPP Technical Specification (TS) 38.213. For the message A (msgA) transmission (e.g., in a 2-step random access channel (RACH) procedure) on the PUSCH, N_{TA}=0 may be used. Further, for the PRACH transmission, N_{TA}=0 may be used by the UE to obtain the initial TA value.

In some configurations, multiple TA values may be supported for the multi-DCI based multi-TRP operation. In this case, a UE may be configured with multiple TAGs in a serving cell. If two TAGs are configured on the special cell (SpCell) (i.e., a PCell or a primary secondary cell (PSCell)) and one of the two configured TAGs (e.g., a first TAG, a TAG 0, or the TAG with the lower TAG ID) may be defined as the primary TAG (PTAG). In some configurations, the CBRA process (e.g., a 4-step RACH procedure) may be used by the UE to acquire the TA value, e.g., for the PTAG.

To determine the PRACH resource for the CBRA process, in one example configuration, the UE may randomly select an SSB among the SSBs whose associated reference signal received power (RSRP) values are greater than a threshold. If none of the SSBs with an RSRP value greater than the threshold is available, the UE may select any available SSB for the CBRA process.

If the UE is not aware of the association between SSBs and TRPs (i.e., which SSBs are associated with the first TRP and which SSBs are associated with the second TRP), the UE may select an SSB associated with either the first TRP or the second TRP. Thus, the PRACH transmission (i.e., a PRACH preamble) may be towards the first TRP or the second TRP. During the CBRA process, the UE may receive an (absolute) TA command including a TA value (e.g., an absolute TA value) in an RAR message (e.g., via a PDSCH) (or in a msgB). To apply the TA value acquired through the CBRA process to the correct TRP, the UE may need to identify the TRP to which the (absolute) TA command applies. In some configurations, the (absolute) TA command may be disambiguated based on a predefined rule.

Further, because two DL reference timings and two “n-TimingAdvanceOffset” values may be supported for a serving cell with two TAGs in the multi-DCI based multi-TRP operation and the CBRA process may be triggered/performed for just one TAG, the UE may need to identify one of the two TAGs to be used for the PRACH.

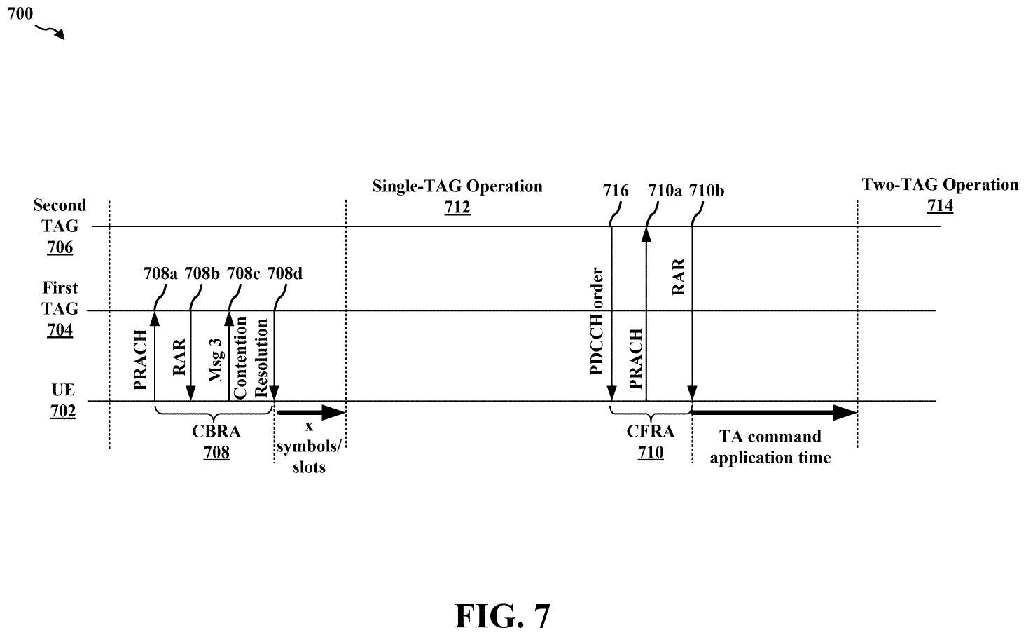

FIG. 7 is a diagram illustrating an example method 700 of wireless communication according to one or more aspects. As shown, two TAGs including a first TAG 704 and a second TAG 706 may be configured for the SpCell. Further, one of the two TAGs maybe the PTAG. The CBRA process 708 may include a PRACH preamble 708a transmitted from the UE 702 to a first network node (e.g., a TRP in the SpCell), a first RAR message 708b transmitted from the first network node to the UE 702, a message 3 (Msg 3) 708c transmitted from the UE 702 to the first network node, and finally a contention resolution message 708d transmitted from the first network node to the UE 702. The first RAR message 708b may include a first (absolute) TA command that may include a first TA value (e.g., an absolute TA value).

After the CBRA process 708 is successfully completed and the UE is in the RRC Connected state, the UE may switch to a single-TAG operation mode 712. In some configurations, the UE may switch to the single-TAG operation mode 712 a preconfigured symbols or slots (e.g., x symbols or slots) after the CBRA process 708 is successfully completed. In some aspects, x may be 0. In other words, the UE may switch to the single-TAG operation mode 712 immediately after the CBRA process 708 is successfully completed. In different configurations, the single TAG used for the single-TAG operation may be one of the first TAG 704, the PTAG, a TAG 0, or the TAG with the lower TAG ID.

Further, the UE 702 may receive a PDCCH order from a second network node (e.g., another TRP in the SpCell). The PDCCH order may trigger a CFRA process 710. The UE may identify an association between the CFRA process 710 and a CORESETPoolIndex value and/or a TRP using any suitable techniques. The CFRA process 710 may include a PRACH preamble 710a (or a msgA in a 2-step RACH procedure) transmitted from the UE 702 to the second network node and a second RAR message 710b (or a msgB in a 2-step RACH procedure) transmitted from the second network node to the UE 702. The second RAR message 710b (or the msgB in a 2-step RACH procedure (not shown)) may include a second (absolute) TA command that may include a second TA value. Accordingly, the UE may switch to a two-TAG operation mode 714 when the (absolute) TA command received in the second RAR message 710b (or the msgB) is applied. In other words, the UE may switch to a two-TAG operation mode 714 after a TA command application time period has passed since the reception at the UE of the second RAR message 710b (or the msgB in a 2-step RACH procedure). Although not shown in detail, in different configurations, the CFRA process 710 may be a 4-step CFRA process or a 2-step CFRA process. For a 4-step CFRA process 710, 710a may be a PRACH preamble (as shown) and 710b may be a (second) RAR message (as shown). Further, for a 2-step CFRA process 710, 710a may be a msgA and 710b may be a msgB.

As mentioned above, the UE may identify an association between the CFRA process 710 and a CORESETPoolIndex value and/or a TRP using any suitable techniques. For example, in one configuration, an RAR message may indicate a TAG ID in the TA command. In another example configuration, the PDCCH order may indicate a TAG ID. In yet another example, SSBs may be divided into two groups, with each TRP being associated with one of the groups. Accordingly, if an SSB associated with a RACH procedure belongs to a particular SSB group (e.g., the first SSB group or the second SSB group), then the TA configuration obtained via the RACH procedure may correspond to the TRP associated with the SSB group. In yet another example configuration, RACH resources may be divided into two groups, with each TRP being associated with one of the groups. Accordingly, for a RACH procedure, if the RACH resource belongs to a particular RACH resource group (e.g., the first RACH resource group or the second RACH resource group), then the TA configuration obtained via the RACH procedure may correspond to the TRP associated with the RACH resource group. In yet another example configuration, PRACH preambles may be divided into two groups, with each TRP being associated with one of the groups. Accordingly, for a RACH procedure, if the PRACH preamble belongs to a particular PRACH preamble group (e.g., the first PRACH preamble group or the second PRACH preamble group), then the TA configuration obtained via the RACH procedure may correspond to the TRP associated with the PRACH preamble group. In yet another example configuration, TAG IDs may be associated with CORESETPoolIndex index values. Accordingly, a TAG ID may be identified based on the CORESETPoolIndex value of the PDCCH order. In yet another example configuration, each TCI state may be associated with a TAG ID. Accordingly, the TAG ID corresponding to a RACH procedure triggered by a PDCCH order may be identified based on the TCI state used to receive the PDCCH order.

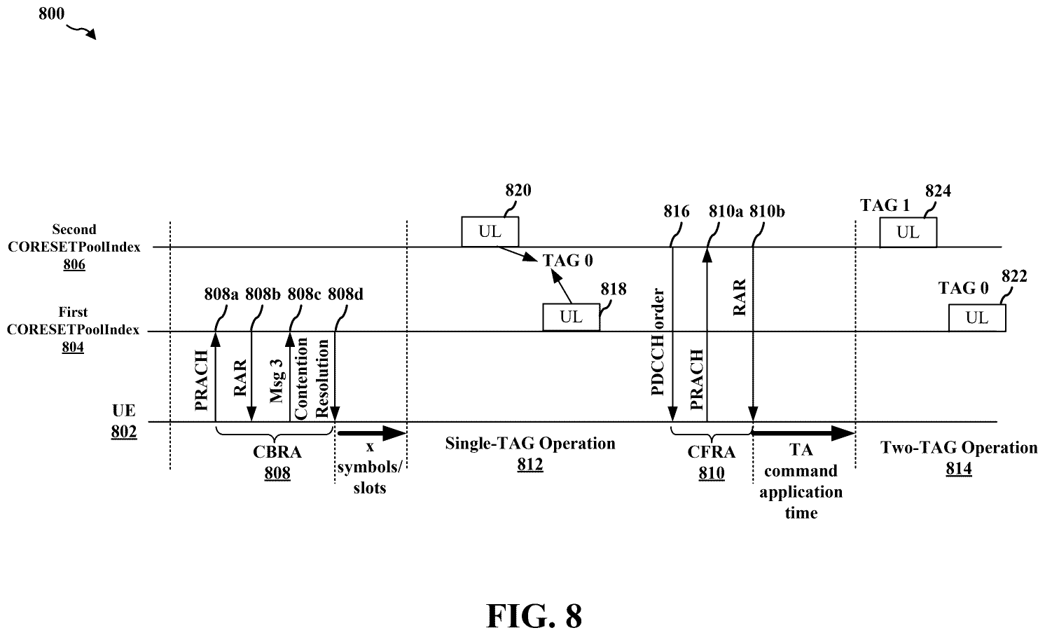

FIG. 8 is a diagram illustrating an example method 800 of wireless communication according to one or more aspects. As shown, the UE 802, the CBRA process 808 including the PRACH preamble 808a, the first RAR message 808b, the Msg 3 808c, the contention resolution message 808d, the single-TAG operation mode 812, the PDCCH order 816, the CFRA process 810 including the PRACH preamble 810a and the second RAR message 810b, and the two-TAG operation mode 814 may be similar to the UE 702, the CBRA process 708 including the PRACH preamble 708a, the first RAR message 708b, the Msg 3 708c, the contention resolution message 708d, the single-TAG operation mode 712, the PDCCH order 716, the CFRA process 710 including the PRACH preamble 710a and the second RAR message 710b, and the two-TAG operation mode 714 in FIG. 7, respectively. Although not shown in detail, in different configurations, the CFRA process 810 may be a 4-step CFRA process or a 2-step CFRA process. For a 4-step CFRA process 810, 810a may be a PRACH preamble (as shown) and 810b may be a (second) RAR message (as shown). Further, for a 2-step CFRA process 810, 810a may be a msgA and 810b may be a msgB.

As shown in FIG. 8, in some configurations, when the UE 802 is in the single-TAG operation mode 812, all UL channels/signals (e.g., UL transmissions 818, 820) may be associated with the first TAG (e.g., a TAG 0 or the TAG with the lower TAG ID). Further, the UE 802 may apply the (absolute) TA command to that TAG (i.e., the first TAG/TAG 0). Moreover, when the UE 802 is in the single-TAG operation mode 812, both CORESETPoolIndex values (e.g., 0 and 1) (i.e., the first CORESETPoolIndex 804 and the second CORESETPoolIndex 806) may be associated with the first TAG (e.g., TAG 0).

When the UE 802 is in the two-TAG operation mode 814 and the (absolute) TA command for the second TAG (e.g., TAG 1) has been acquired and applied by the UE based on the CFRA process 810, the UL channels/signals (e.g., UL transmissions 822, 824) may be associated with the respective TAG (the first TAG/TAG 0 or the second TAG/TAG 1) based on the CORESETPoolIndex values with which the UL channels/signals are associated. In particular, as shown, the UL transmission 822, being associated with the first CORESETPoolIndex 804, may be associated with the first TAG/TAG 0. Further, as the UL transmission 824 is associated with the second CORESETPoolIndex 806, the UL transmission 824 may be associated with the second TAG/TAG 1.

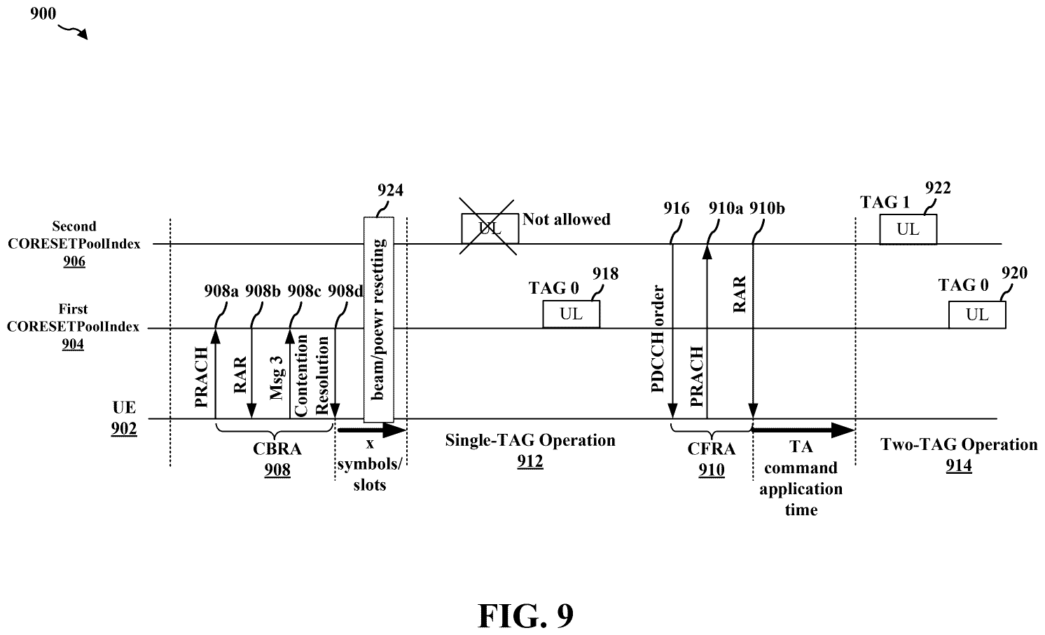

FIG. 9 is a diagram illustrating an example method 900 of wireless communication according to one or more aspects. As shown, the UE 902, the CBRA process 908 including the PRACH preamble 908a, the first RAR message 908b, the Msg 3 908c, the contention resolution message 908d, the single-TAG operation mode 912, the PDCCH order 916, the CFRA process 910 including the PRACH preamble 910a and the second RAR message 910b, and the two-TAG operation mode 914 may be similar to the UE 702, the CBRA process 708 including the PRACH preamble 708a, the first RAR message 708b, the Msg 3 708c, the contention resolution message 708d, the single-TAG operation mode 712, the PDCCH order 716, the CFRA process 710 including the PRACH preamble 710a and the second RAR message 710b, and the two-TAG operation mode 714 in FIG. 7, respectively. Although not shown in detail, in different configurations, the CFRA process 910 may be a 4-step CFRA process or a 2-step CFRA process. For a 4-step CFRA process 910, 910a may be a PRACH preamble (as shown) and 910b may be a (second) RAR message (as shown). Further, for a 2-step CFRA process 910, 910a may be a msgA and 910b may be a msgB.

As shown in FIG. 9, in some configurations, when the UE 902 is in the single-TAG operation mode 912, UL channels/signals (e.g., the UL communication 918) associated with the CORESETPoolIndex value of 0 (i.e., the first CORESETPoolIndex 904) may be transmitted based on the (absolute) TA command received via the first RAR message 908b, where the UE may apply the (absolute) TA command received via the first RAR message 908b to the single TAG (e.g., the PTAG/the first TAG/TAG 0). Further, when the UE 902 is in the single-TAG operation mode 912, UL channels/signals associated with the CORESETPoolIndex value of 1 (i.e., the second CORESETPoolIndex 906) may not be transmitted (i.e., the transmission may not be allowed).

In some configurations, the physical TRP associated with the CORESETPoolIndex value of 0 may change (the physical TRP associated with CORESETPoolIndex=0 may depend on the SSB selected and used for the CBRA process). Therefore, the DL reference timing for CORESETPoolIndex=0 may be determined based on the DL reference timing of the selected SSB (i.e., corresponding to a physical TRP). Therefore, in one configuration, after the CBRA process 908 is successfully completed, at 924, the DL/UL beam and/or UL power control parameters may be reset for data/control channels (e.g., based on a configuration provided by a network entity). Further, the DL reference timing for the TA may also be changed (e.g., by the UE) based on the SSB used for the CBRA process 908.

When the UE 902 is in the two-TAG operation mode 914 and the (absolute) TA command for the second TAG (e.g., TAG 1) has been acquired and applied by the UE based on the CFRA process 910, the UL channels/signals (e.g., UL transmissions 920, 922) may be associated with the respective TAG (the first TAG/TAG 0 or the second TAG/TAG 1) based on the CORESETPoolIndex values with which the UL channels/signals are associated. In particular, as shown, the UL transmission 920, being associated with the first CORESETPoolIndex 904 (e.g., CORESETPoolIndex=0), may be associated with the first TAG/TAG 0. Further, as the UL transmission 922 is associated with the second CORESETPoolIndex 806 (e.g., CORESETPoolIndex=1), the UL transmission 922 may be associated with the second TAG/TAG 1.

In some configurations, the UE may select the UL transmission timing for the PRACH preamble transmission based on the random access type. In particular, in one configuration, for a CBRA process, the UE may use a default DL reference timing and a default “n-TimingAdvanceOffset” value to determine the UL transmission timing for the PRACH preamble. For example, the default DL reference timing and the default “n-TimingAdvanceOffset” value may be the first DL reference timing and the first “n-TimingAdvanceOffset” value, respectively. In another example, the default DL reference timing and the default “n-TimingAdvanceOffset” value may be the DL reference timing and the “n-TimingAdvanceOffset” value associated with the PTAG, respectively. In yet another example, the default DL reference timing and the default “n-TimingAdvanceOffset” value may be the DL reference timing and the “n-TimingAdvanceOffset” value associated with CORESETPoolIndex=0.

In another configuration, for a CBRA process, the UE may determine the UL transmission timing for the PRACH preamble based on the SSB selected and used for the CBRA process.

In one configuration, for a CFRA process, the UE may determine the UL transmission timing for the PRACH preamble based on the PDCCH order that triggers the CFRA process. In particular, for example, if the PDCCH order triggers the CFRA process for a first TAG or a first CORESETPoolIndex value, the DL reference timing and the “n-TimingAdvanceOffset” value associated with the first TAG/CORESETPoolIndex value may be used by the UE in the determination of the UL transmission timing for the PRACH preamble. Further, if the PDCCH order triggers the CFRA process for a second TAG or a second CORESETPoolIndex value, the DL reference timing and the “n-TimingAdvanceOffset” value associated with the second TAG/CORESETPoolIndex value may be used by the UE in the determination of the UL transmission timing for the PRACH preamble.

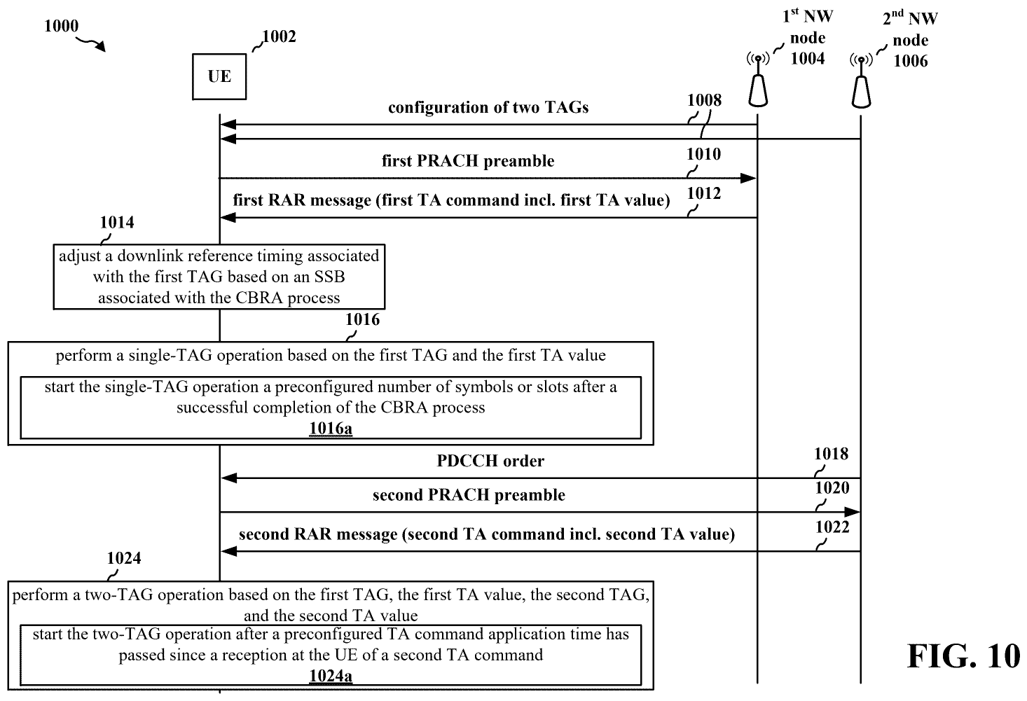

FIG. 10 is a diagram of a communication flow 1000 of a method of wireless communication. The UE 1002 may implement aspects of the UE 104/350/702/802/902. At 1008, the UE 1002 may receive a configuration of two TAGs for an SpCell from a network entity 1004/1006 (or from yet another network entity, not shown). The two TAGs may include a first TAG and a second TAG.

In one configuration, the first TAG may correspond to one of a PTAG, a TAG 0, or a TAG with the lower TAG ID.

In one configuration, at 1010, the UE 1002 may transmit, for the first network node 1004, a first PRACH preamble associated with the CBRA process based on one or more first preconfigured TA parameters.

At 1012, the UE 1002 may receive a first (absolute) TA command in a first RAR message associated with the CBRA process from the first network node 1004. The first (absolute) TA command may include a first TA value.

In one configuration, at 1014, the UE 1002 may adjust a downlink reference timing associated with the first TAG based on an SSB associated with the CBRA process.

At 1016, the UE 1002 may perform a single-TAG operation based on the first TAG and the first TA value.

In particular, at 1016a, the UE 1002 may start the single-TAG operation a preconfigured number of symbols or slots after a successful completion of the CBRA process.

At 1018, the UE 1002 may receive a PDCCH order from the second network node 1006. The PDCCH order may trigger a CFRA process. In other words, the CFRA process may be associated with the PDCCH order.

In one configuration, at 1020, the UE 1002 may transmit, for the second network node 1006, a second PRACH preamble associated with the CFRA process based on one or more second TA parameters.

At 1022, the UE 1002 may receive a second (absolute) TA command associated with the second TAG in a second RAR message associated with the CFRA process from the second network node 1006. The second (absolute) TA command may include a second TA value.

At 1024, the UE 1002 may perform a two-TAG operation based on the first TAG, the first TA value, the second TAG, and the second TA value.

In particular, at 1024a, the UE 1002 may start the two-TAG operation after a preconfigured TA command application time has passed since a reception at the UE 1002 of the second (absolute) TA command in a second RAR message associated with the CFRA process.

In one configuration, during the single-TAG operation, the first TAG may be associated with two CORESETPoolIndex values including a first CORESETPoolIndex value and a second CORESETPoolIndex value. During the two-TAG operation, the first TAG and the second TAG may be associated with the first CORESETPoolIndex value and the second CORESETPoolIndex value, respectively.

In one configuration, during the single-TAG operation, the first TAG may be associated with a preconfigured CORESETPoolIndex value. In one configuration, during the single-TAG operation, first uplink transmissions associated with the preconfigured CORESETPoolIndex value from the UE 1002 may be permitted. Second uplink transmissions not associated with the preconfigured CORESETPoolIndex value from the UE 1002 may not be permitted.

In one configuration, during the two-TAG operation, first uplink transmissions associated with the preconfigured CORESETPoolIndex value from the UE 1002 and second uplink transmissions associated with a second CORESETPoolIndex value different from the preconfigured CORESETPoolIndex value from the UE 1002 may be permitted.

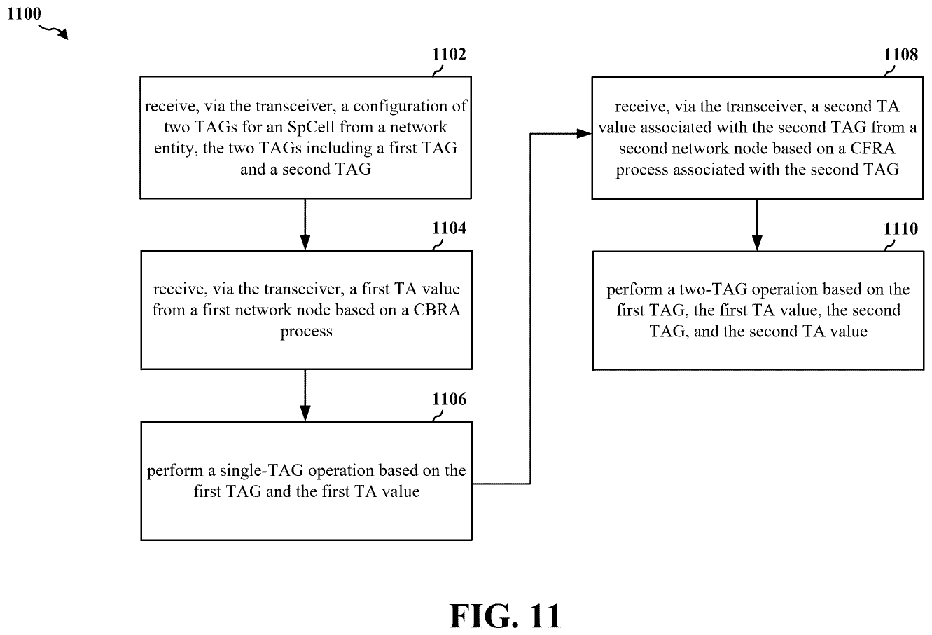

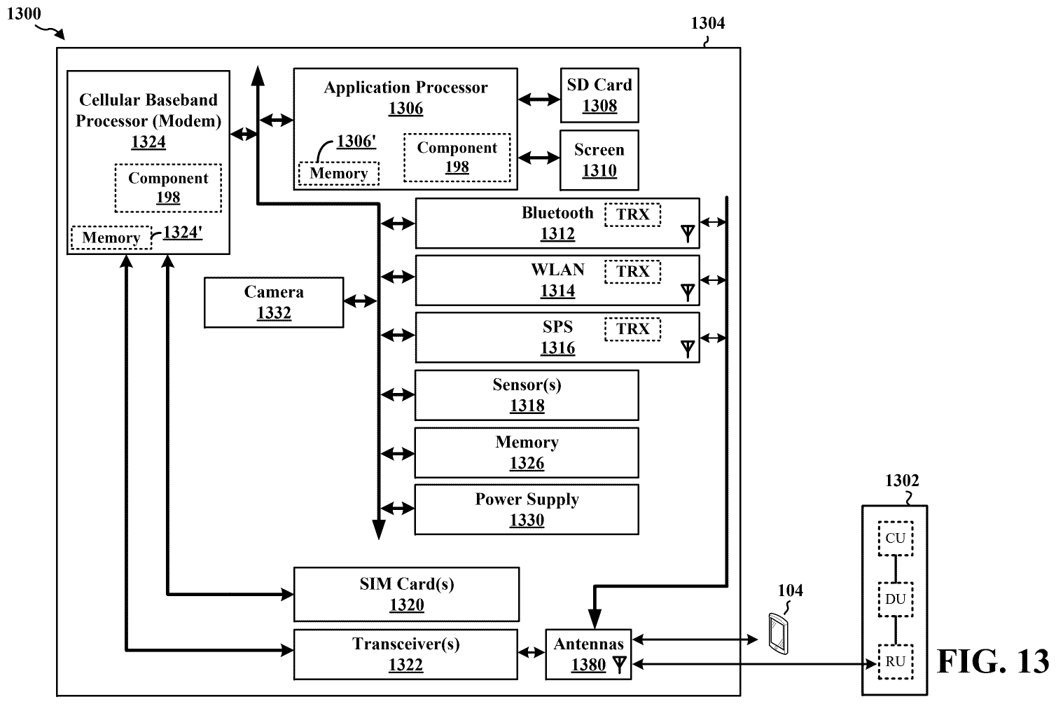

FIG. 11 is a flowchart 1100 of a method of wireless communication. The method may be performed by a UE (e.g., the UE 104/350/1002, the apparatus 1304). At 1102, the UE may receive a configuration of two TAGs for an SpCell from a network entity. The two TAGs may include a first TAG and a second TAG. For example, 1102 may be performed by the component 198 in FIG. 13. Referring to FIG. 10, at 1008, the UE 1002 may receive a configuration of two TAGs for an SpCell from a network entity 1004/1006.

At 1104, the UE may receive a first TA value from a first network node based on a CBRA process. For example, 1104 may be performed by the component 198 in FIG. 13. Referring to FIG. 10, at 1012, the UE 1002 may receive a first TA value from a first network node 1004 based on a CBRA process.

At 1106, the UE may perform a single-TAG operation based on the first TAG and the first TA value. For example, 1106 may be performed by the component 198 in FIG. 13. Referring to FIG. 10, at 1016, the UE 1002 may perform a single-TAG operation based on the first TAG and the first TA value.

At 1108, the UE may receive a second TA value associated with the second TAG from a second network node based on a CFRA process associated with the second TAG. For example, 1108 may be performed by the component 198 in FIG. 13. Referring to FIG. 10, at 1022, the UE 1002 may receive a second TA value associated with the second TAG from a second network node 1006 based on a CFRA process associated with the second TAG.

At 1110, the UE may perform a two-TAG operation based on the first TAG, the first TA value, the second TAG, and the second TA value. For example, 1110 may be performed by the component 198 in FIG. 13. Referring to FIG. 10, at 1024, the UE 1002 may perform a two-TAG operation based on the first TAG, the first TA value, the second TAG, and the second TA value.

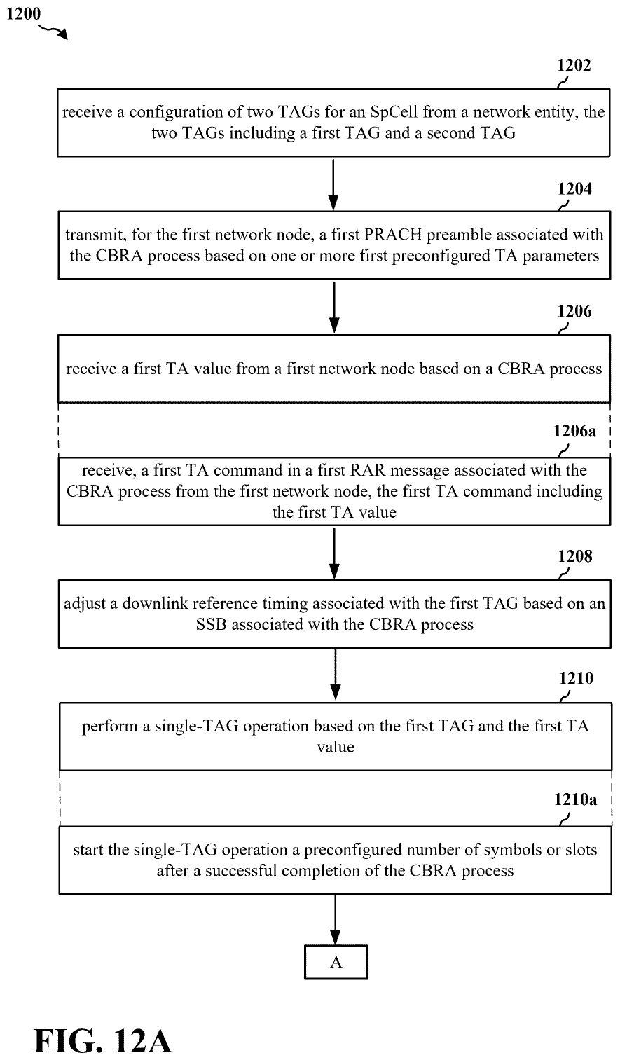

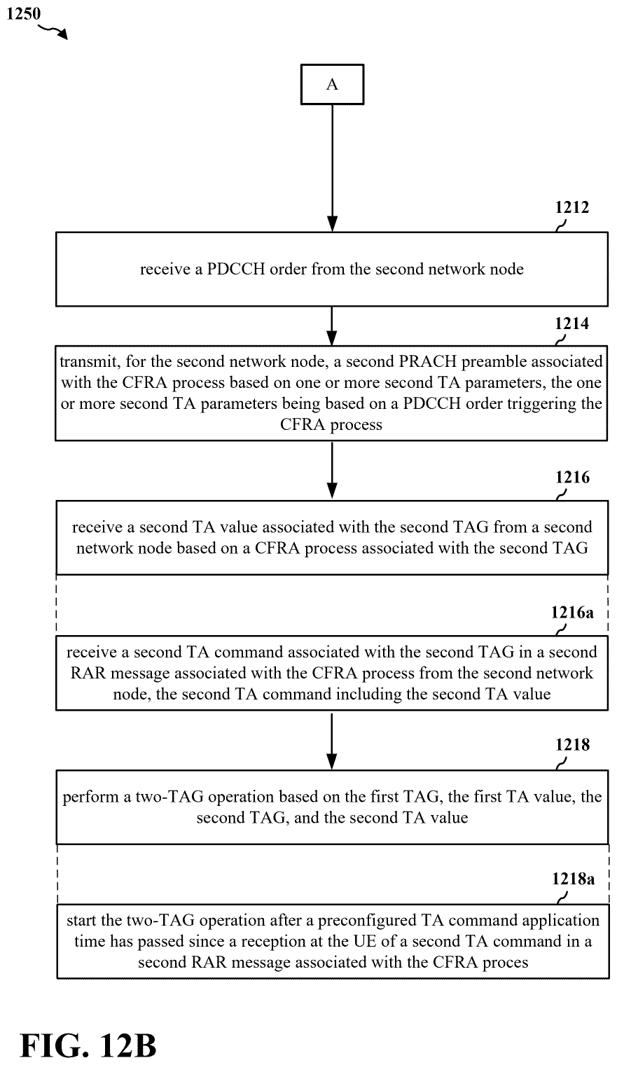

FIGS. 12A, 12B are flowcharts 1200, 1250 of a method of wireless communication. The method may be performed by a UE (e.g., the UE 104/350/1002; the apparatus 1304). At 1202, the UE may receive a configuration of two TAGs for an SpCell from a network entity. The two TAGs may include a first TAG and a second TAG. For example, 1202 may be performed by the component 198 in FIG. 13. Referring to FIG. 10, at 1008, the UE 1002 may receive a configuration of two TAGs for an SpCell from a network entity 1004/1006.

At 1206, the UE may receive a first TA value from a first network node based on a CBRA process. For example, 1206 may be performed by the component 198 in FIG. 13. Referring to FIG. 10, at 1012, the UE 1002 may receive a first TA value from a first network node 1004 based on a CBRA process.

At 1210, the UE may perform a single-TAG operation based on the first TAG and the first TA value. For example, 1210 may be performed by the component 198 in FIG. 13. Referring to FIG. 10, at 1016, the UE 1002 may perform a single-TAG operation based on the first TAG and the first TA value.

At 1216, the UE may receive a second TA value associated with the second TAG from a second network node based on a CFRA process associated with the second TAG. For example, 1216 may be performed by the component 198 in FIG. 13. Referring to FIG. 10, at 1022, the UE 1002 may receive a second TA value associated with the second TAG from a second network node 1006 based on a CFRA process associated with the second TAG.

At 1218, the UE may perform a two-TAG operation based on the first TAG, the first TA value, the second TAG, and the second TA value. For example, 1218 may be performed by the component 198 in FIG. 13. Referring to FIG. 10, at 1024, the UE 1002 may perform a two-TAG operation based on the first TAG, the first TA value, the second TAG, and the second TA value.

In one configuration, the first TAG may correspond to one of a PTAG, a TAG 0, or a TAG with a lower ID.

In one configuration, to perform, at 1210, the single-TAG operation, at 1210a, the UE may start the single-TAG operation a preconfigured number of symbols or slots after a successful completion of the CBRA process. For example, 1210a may be performed by the component 198 in FIG. 13. Referring to FIG. 10, at 1016a, the UE 1002 may start the single-TAG operation a preconfigured number of symbols or slots after a successful completion of the CBRA process.

In one configuration, to perform, at 1218, the two-TAG operation, at 1218a, the UE may start the two-TAG operation after a preconfigured TA command application time has passed since a reception at the UE of a second TA command in a second RAR message associated with the CFRA process. For example, 1218a may be performed by the component 198 in FIG. 13. Referring to FIG. 10, at 1024a, the UE 1002 may start the two-TAG operation after a preconfigured TA command application time has passed since a reception at the UE 1002 of a second TA command in a second RAR message associated with the CFRA process.

In one configuration, at 1212 (from A), the UE may receive a PDCCH order from the second network node. The CFRA process may be associated with the PDCCH order. For example, 1212 may be performed by the component 198 in FIG. 13. Referring to FIG. 10, at 1018, the UE 1002 may receive a PDCCH order from the second network node 1006.

In one configuration, to receive, at 1206, the first TA value associated with the first TAG, at 1206a, the UE may receive a first TA command in a first RAR message associated with the CBRA process from the first network node. The first TA command may include the first TA value. For example, 1206a may be performed by the component 198 in FIG. 13. Referring to FIG. 10, at 1012, the UE 1002 may receive a first TA command in a first RAR message associated with the CBRA process from the first network node 1004.

In one configuration, to receive, at 1216, the second TA value associated with the second TAG, at 1216a, the UE may receive a second TA command associated with the second TAG in a second RAR message associated with the CFRA process from the second network node. The second TA command may include the second TA value. For example, 1216a may be performed by the component 198 in FIG. 13. Referring to FIG. 10, at 1022, the UE 1002 may receive a second TA command associated with the second TAG in a second RAR message associated with the CFRA process from the second network node 1006.

In one configuration, during the single-TAG operation, the first TAG may be associated with two CORESETPoolIndex values including a first CORESETPoolIndex value and a second CORESETPoolIndex value. During the two-TAG operation, the first TAG and the second TAG may be associated with the first CORESETPoolIndex value and the second CORESETPoolIndex value, respectively.

In one configuration, during the single-TAG operation, the first TAG may be associated with a preconfigured CORESETPoolIndex value.

In one configuration, referring to FIG. 10, during the single-TAG operation, first uplink transmissions associated with the preconfigured CORESETPoolIndex value from the UE 1002 may be permitted. Second uplink transmissions not associated with the preconfigured CORESETPoolIndex value from the UE 1002 may not be permitted.

In one configuration, referring to FIG. 10, during the two-TAG operation, first uplink transmissions associated with the preconfigured CORESETPoolIndex value from the UE 1002 and second uplink transmissions associated with a second CORESETPoolIndex value different from the preconfigured CORESETPoolIndex value from the UE 1002 may be permitted.

In one configuration, at 1208, the UE may adjust a downlink reference timing associated with the first TAG based on an SSB associated with the CBRA process. For example, 1208 may be performed by the component 198 in FIG. 13. Referring to FIG. 10, at 1014, the UE 1002 may adjust a downlink reference timing associated with the first TAG based on an SSB associated with the CBRA process.

In one configuration, at 1204, the UE may transmit, for the first network node, a first PRACH preamble associated with the CBRA process based on one or more first preconfigured TA parameters. For example, 1204 may be performed by the component 198 in FIG. 13. Referring to FIG. 10, at 1010, the UE 1002 may transmit, for the first network node 1004, a first PRACH preamble associated with the CBRA process based on one or more first preconfigured TA parameters.

In one configuration, at 1214, the UE may transmit, for the second network node, a second PRACH preamble associated with the CFRA process based on one or more second TA parameters. The one or more second TA parameters may be based on a PDCCH order triggering the CFRA process. For example, 1214 may be performed by the component 198 in FIG. 13. Referring to FIG. 10, at 1020, the UE 1002 may transmit, for the second network node 1006, a second PRACH preamble associated with the CFRA process based on one or more second TA parameters.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to receive a configuration of two TAGs for an SpCell from a network entity. The two TAGs may include a first TAG and a second TAG. The component 198 is configured to receive a first TA value from a first network node based on a CBRA process. The component 198 is configured to perform a single-TAG operation based on the first TAG and the first TA value. The component 198 is configured to receive a second TA value associated with the second TAG from a second network node based on a CFRA process associated with the second TAG. The component 198 is configured to perform a two-TAG operation based on the first TAG, the first TA value, the second TAG, and the second TA value. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving a configuration of two TAGs for an SpCell from a network entity. The two TAGs may include a first TAG and a second TAG. The apparatus 1304, and in particular the cellular baseband processor 1324 and/or the application processor 1306, includes means for receiving a first TA value from a first network node based on a CBRA process. The apparatus 1304, and in particular the cellular baseband processor 1324 and/or the application processor 1306, includes means for performing a single-TAG operation based on the first TAG and the first TA value. The apparatus 1304, and in particular the cellular baseband processor 1324 and/or the application processor 1306, includes means for receiving a second TA value associated with the second TAG from a second network node based on a CFRA process associated with the second TAG. The apparatus 1304, and in particular the cellular baseband processor 1324 and/or the application processor 1306, includes means for performing a two-TAG operation based on the first TAG, the first TA value, the second TAG, and the second TA value.

In one configuration, the first TAG may correspond to one of a PTAG, a TAG 0, or a TAG with a lower ID. In one configuration, the means for performing the single-TAG operation may be further configured to start the single-TAG operation a preconfigured number of symbols or slots after a successful completion of the CBRA process. In one configuration, the means for performing the two-TAG operation may be further configured to start the two-TAG operation after a preconfigured TA command application time has passed since a reception at the UE of a second TA command in a second RAR message associated with the CFRA process. In one configuration, the apparatus 1304, and in particular the cellular baseband processor 1324 and/or the application processor 1306, includes means for receiving a PDCCH order from the second network node. The CFRA process may be associated with the PDCCH order. In one configuration, the means for receiving the first TA value associated with the first TAG may be further configured to receive a first TA command in a first RAR message associated with the CBRA process from the first network node. The first TA command may include the first TA value. In one configuration, the means for receiving the second TA value associated with the second TAG may be further configured to receive a second TA command associated with the second TAG in a second RAR message associated with the CFRA process from the second network node. The second TA command may include the second TA value. In one configuration, during the single-TAG operation, the first TAG may be associated with two CORESETPoolIndex values including a first CORESETPoolIndex value and a second CORESETPoolIndex value. During the two-TAG operation, the first TAG and the second TAG may be associated with the first CORESETPoolIndex value and the second CORESETPoolIndex value, respectively. In one configuration, during the single-TAG operation, the first TAG may be associated with a preconfigured CORESETPoolIndex value. In one configuration, during the single-TAG operation, first uplink transmissions associated with the preconfigured CORESETPoolIndex value from the UE may be permitted. Second uplink transmissions not associated with the preconfigured CORESETPoolIndex value from the UE may not be permitted. In one configuration, during the two-TAG operation, first uplink transmissions associated with the preconfigured CORESETPoolIndex value from the UE and second uplink transmissions associated with a second CORESETPoolIndex value different from the preconfigured CORESETPoolIndex value from the UE may be permitted. In one configuration, the apparatus 1304, and in particular the cellular baseband processor 1324 and/or the application processor 1306, includes means for adjusting a downlink reference timing associated with the first TAG based on an SSB associated with the CBRA process. In one configuration, the apparatus 1304, and in particular the cellular baseband processor 1324 and/or the application processor 1306, includes means for transmitting, for the first network node, a first PRACH preamble associated with the CBRA process based on one or more first preconfigured TA parameters. The apparatus 1304, and in particular the cellular baseband processor 1324 and/or the application processor 1306, includes means for transmitting, for the second network node, a second PRACH preamble associated with the CFRA process based on one or more second TA parameters. The one or more second TA parameters may be based on a PDCCH order triggering the CFRA process.

The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

Referring back to FIGS. 4-13, a UE may receive, via a transceiver, a configuration of two TAGs for an SpCell from a network entity. The two TAGs may include a first TAG and a second TAG. The UE may receive, via the transceiver, a first TA value from a first network node based on a CBRA process. The UE may perform a single-TAG operation based on the first TAG and the first TA value. The UE may receive, via the transceiver, a second TA value associated with the second TAG from a second network node based on a CFRA process associated with the second TAG. The UE may perform a two-TAG operation based on the first TAG, the first TA value, the second TAG, and the second TA value. Accordingly, a TA command may be applied to a correct TAG and/or a correct CORESET pool (which may correspond to a CORESETPoolIndex value) in a multi-DCI based multi-TRP operation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a configuration of two TAGs for an SpCell from a network entity, the two TAGs including a first TAG and a second TAG; receiving a first TA value from a first network node based on a CBRA process; performing a single-TAG operation based on the first TAG and the first TA value; receiving a second TA value associated with the second TAG from a second network node based on a CFRA process associated with the second TAG; and performing a two-TAG operation based on the first TAG, the first TA value, the second TAG, and the second TA value.

Aspect 2 is the method of aspect 1, where the first TAG corresponds to one of a PTAG, a TAG 0, or a TAG with a lower ID.

Aspect 3 is the method of any of aspects 1 and 2, where performing the single-TAG operation further includes: starting the single-TAG operation a preconfigured number of symbols or slots after a successful completion of the CBRA process.

Aspect 4 is the method of any of aspects 1 to 3, where performing the two-TAG operation further includes: starting the two-TAG operation after a preconfigured TA command application time has passed since a reception at the UE of a second TA command in a second RAR message associated with the CFRA process.

Aspect 5 is the method of any of aspects 1 to 4, further including: receiving a PDCCH order from the second network node, where the CFRA process is associated with the PDCCH order.

Aspect 6 is the method of any of aspects 1 to 5, where receiving the first TA value further includes: receiving a first TA command in a first RAR message associated with the CBRA process from the first network node, the first TA command including the first TA value.

Aspect 7 is the method of any of aspects 1 to 6, where receiving the second TA value associated with the second TAG further includes: receiving a second TA command associated with the second TAG in a second RAR message associated with the CFRA process from the second network node, the second TA command including the second TA value.

Aspect 8 is the method of any of aspects 1 to 7, where during the single-TAG operation, the first TAG is associated with two CORESETPoolIndex values including a first CORESETPoolIndex value and a second CORESETPoolIndex value, and during the two-TAG operation, the first TAG and the second TAG are associated with the first CORESETPoolIndex value and the second CORESETPoolIndex value, respectively.

Aspect 9 is the method of any of aspects 1 to 7, where during the single-TAG operation, the first TAG is associated with a preconfigured CORESETPoolIndex value.

Aspect 10 is the method of aspect 9, where during the single-TAG operation, first uplink transmissions associated with the preconfigured CORESETPoolIndex value from the UE are permitted, and second uplink transmissions not associated with the preconfigured CORESETPoolIndex value from the UE are not permitted.

Aspect 11 is the method of any of aspects 9 and 10, where during the two-TAG operation, first uplink transmissions associated with the preconfigured CORESETPoolIndex value from the UE and second uplink transmissions associated with a second CORESETPoolIndex value different from the preconfigured CORESETPoolIndex value from the UE are permitted.

Aspect 12 is the method of any of aspects 9 to 11, further including: adjusting a downlink reference timing associated with the first TAG based on an SSB associated with the CBRA process.

Aspect 13 is the method of any of aspects 1 to 12, further including: transmitting, for the first network node, a first PRACH preamble associated with the CBRA process based on one or more first preconfigured TA parameters; and transmitting, for the second network node, a second PRACH preamble associated with the CFRA process based on one or more second TA parameters, the one or more second TA parameters being based on a PDCCH order triggering the CFRA process.

Aspect 14 is an apparatus for wireless communication including at least one processor coupled to a memory and, based at least in part on information stored in the memory, the at least one processor is configured to implement a method as in any of aspects 1 to 13.

Aspect 15 may be combined with aspect 14 and further includes a transceiver coupled to the at least one processor.

Aspect 16 is an apparatus for wireless communication including means for implementing any of aspects 1 to 13.

Aspect 17 is a non-transitory computer-readable storage medium storing computer executable code, where the code when executed by a processor causes the processor to implement any of aspects 1 to 13.

Various aspects have been described herein. These and other aspects are within the scope of the following claims.

1. An apparatus for wireless communication at a user equipment (UE), comprising:
a transceiver;
a memory; and
at least one processor coupled to the transceiver and the memory and, based at least in part on information stored in the memory, the at least one processor is configured to:
receive, via the transceiver, a configuration of two timing advance groups (TAGs) for a special cell (SpCell) from a network entity, the two TAGs comprising a first TAG and a second TAG;
receive, via the transceiver, a first timing advance (TA) value from a first network node based on a contention-based random access (CBRA) process;
perform a single-TAG operation based on the first TAG and the first TA value;
receive, via the transceiver, a second TA value associated with the second TAG from a second network node based on a contention-free random access (CFRA) process associated with the second TAG; and
perform a two-TAG operation based on the first TAG, the first TA value, the second TAG, and the second TA value.

2. The apparatus of claim 1, wherein the first TAG corresponds to one of a primary TAG (PTAG), a TAG 0, or a TAG with a lower identifier (ID).

3. The apparatus of claim 1, wherein to perform the single-TAG operation, the at least one processor is further configured to:
start the single-TAG operation a preconfigured number of symbols or slots after a successful completion of the CBRA process.

4. The apparatus of claim 1, wherein to perform the two-TAG operation, the at least one processor is further configured to:
start the two-TAG operation after a preconfigured TA command application time has passed since a reception at the UE of a second TA command in a second random access response (RAR) message associated with the CFRA process.

5. The apparatus of claim 1, the at least one processor being further configured to:
receive, via the transceiver, a physical downlink control channel (PDCCH) order from the second network node, wherein the CFRA process is associated with the PDCCH order.

6. The apparatus of claim 1, wherein to receive the first TA value, the at least one processor is further configured to:
receive, via the transceiver, a first TA command in a first random access response (RAR) message associated with the CBRA process from the first network node, the first TA command including the first TA value.

7. The apparatus of claim 1, wherein to receive the second TA value associated with the second TAG, the at least one processor is further configured to:
receive, via the transceiver, a second TA command associated with the second TAG in a second random access response (RAR) message associated with the CFRA process from the second network node, the second TA command including the second TA value.

8. (canceled)

9. (canceled)

10. (canceled)

11. (canceled)

12. (canceled)

13. The apparatus of claim 1, the at least one processor being further configured to:
transmit, for the first network node and via the transceiver, a first physical random access channel (PRACH) preamble associated with the CBRA process based on one or more first preconfigured TA parameters; and
transmit, for the second network node and via the transceiver, a second PRACH preamble associated with the CFRA process based on one or more second TA parameters, the one or more second TA parameters being based on a physical downlink control channel (PDCCH) order triggering the CFRA process.

14. A method of wireless communication at a user equipment (UE), comprising:
receiving a configuration of two TAGs for an SpCell from a network entity, the two TAGs comprising a first TAG and a second TAG;
receiving a first TA value from a first network node based on a CBRA process;
performing a single-TAG operation based on the first TAG and the first TA value;
receiving a second TA value associated with the second TAG from a second network node based on a CFRA process associated with the second TAG; and
performing a two-TAG operation based on the first TAG, the first TA value, the second TAG, and the second TA value.

15. The method of claim 14, wherein the first TAG corresponds to one of a PTAG, a TAG 0, or a TAG with a lower ID.

16. The method of claim 14, wherein performing the single-TAG operation further comprises:
starting the single-TAG operation a preconfigured number of symbols or slots after a successful completion of the CBRA process.

17. The method of claim 14, wherein performing the two-TAG operation further comprises:
starting the two-TAG operation after a preconfigured TA command application time has passed since a reception at the UE of a second TA command in a second RAR message associated with the CFRA process.

18. (canceled)

19. The method of claim 14, wherein receiving the first TA value further comprises:
receiving a first TA command in a first RAR message associated with the CBRA process from the first network node, the first TA command including the first TA value.

20. The method of claim 14, wherein receiving the second TA value associated with the second TAG further comprises:
receiving a second TA command associated with the second TAG in a second RAR message associated with the CFRA process from the second network node, the second TA command including the second TA value.

21. The method of claim 14, wherein during the single-TAG operation, the first TAG is associated with two CORESETPoolIndex values including a first CORESETPoolIndex value and a second CORESETPoolIndex value, and during the two-TAG operation, the first TAG and the second TAG are associated with the first CORESETPoolIndex value and the second CORESETPoolIndex value, respectively.

22. The method of claim 14, wherein during the single-TAG operation, the first TAG is associated with a preconfigured CORESETPoolIndex value.

23. The method of claim 22, wherein during the single-TAG operation, first uplink transmissions associated with the preconfigured CORESETPoolIndex value from the UE are permitted, and second uplink transmissions not associated with the preconfigured CORESETPoolIndex value from the UE are not permitted.

24. The method of claim 22, wherein during the two-TAG operation, first uplink transmissions associated with the preconfigured CORESETPoolIndex value from the UE and second uplink transmissions associated with a second CORESETPoolIndex value different from the preconfigured CORESETPoolIndex value from the UE are permitted.

25. (canceled)

26. (canceled)

27. An apparatus for wireless communication at a user equipment (UE), comprising:
means for receiving a configuration of two TAGs for an SpCell from a network entity, the two TAGs comprising a first TAG and a second TAG;
means for receiving a first TA value from a first network node based on a CBRA process;
means for performing a single-TAG operation based on the first TAG and the first TA value;
means for receiving a second TA value associated with the second TAG from a second network node based on a CFRA process associated with the second TAG; and
means for performing a two-TAG operation based on the first TAG, the first TA value, the second TAG, and the second TA value.

28. The apparatus of claim 27, wherein the first TAG corresponds to one of a PTAG, a TAG 0, or a TAG with a lower ID.

29. (canceled)

30. (canceled)
